(19) United States
(12) Patent Application Publication
(10) Pub. No.: US 2022/0370982 A1
(43) Pub. Date: Nov. 24, 2022

(54) IONIC-FUNCTIONALIZED WOOD PULP AND RELATED METHODS FOR WATER TREATMENT

(71) Applicant: THE REGENTS OF THE UNIVERSITY OF MICHIGAN, Ann Arbor, MI (US)

(72) Inventors: Anne J. McNeil, Ann Arbor, MI (US); Justin T. Harris, Milford, MA (US)

(21) Appl. No.: 17/749,276

(22) Filed: May 20, 2022

Related U.S. Application Data
(60) Provisional application No. 63/191,491, filed on May 21, 2021.

(51) Int. Cl. B01J 20/24; B01J 20/28; B01J 20/30; B01J 20/34; C02F 1/28

(52) U.S. Cl. CPC B01J 20/24; B01J 20/28023; B01J 20/28016; B01J 20/3085; B01J 20/3425; C02F 1/286; C02F 2101/36

(57) ABSTRACT

The disclosure relates to modified wood pulp and methods using the same for removal for per- and polyfluoroalkyl substances (collectively “PFAS”) from contaminated water. Cationic-modified wood pulp can be used to adsorb anionic PFAS contaminants from water, and anionic-modified wood pulp can be used to adsorb cationic PFAS contaminants from water. The modified wood pulp has high adsorption efficiencies, rapid adsorption kinetics, and high adsorption efficiencies for a range of different PFAS contaminants.

### CROSS REFERENCE TO RELATED APPLICATION

Priority is claimed to U.S. Provisional Application No. 63/191,491 filed on May 21, 2021, which is incorporated herein by reference in its entirety.

### STATEMENT OF GOVERNMENT INTEREST

None.

### BACKGROUND OF THE DISCLOSURE

### Field of the Disclosure

The disclosure relates to modified wood pulp and methods using the same for removal for per- and polyfluoroalkyl substances from contaminated water. Cationic-modified wood pulp can be used to adsorb anionic contaminants from water, and anionic-modified wood pulp can be used to adsorb cationic contaminants from water.

### Background

Per- and polyfluoroalkyl substances (“PFAS”) are pervasive and persistent. Dubbed ‘forever chemicals’ due to their inability to biodegrade, a staggering ˜98% of the US population has measurable levels of PFAS in their blood. One significant source of environmental PFAS is aqueous film-forming foam (AFFF) formulations used as fire-extinguishing foam, which are dispersed in outdoor, uncontained environments, inadvertently contaminating nearby soil, sediment, surface water, and groundwater. Sites where fire-training exercises have been conducted have some of the highest recorded PFAS concentrations in groundwater. PFAS are present at some level (>10 ng/L) in the drinking water for an estimated 110 million US residents. Remediation strategies are urgently needed to attenuate the detrimental impacts of environmental PFAS.

Some remediation technologies include adsorption of PFAS onto solid substrates for disposal either through landfilling or incineration. In this context, many US municipalities use granular activated carbon (GAC) for potable water purification. GAC is a porous material with a high internal surface area that is manufactured from charcoal, coal, peat, wood, or coconut shells. GAC adsorbs many volatile organic compounds, organic matter, and synthetic chemicals, including PFAS. However, GAC poorly adsorbs some contaminants, including short-chain and branched PFAS. In addition, most of the surface area in GAC is internal due to its highly porous structure. As a consequence, GAC exhibits slow adsorption kinetics as analytes must first diffuse into the pores. Moreover, GAC is easily fouled by organic material, requiring frequent and costly regeneration or replacement. To summarize, key gaps for conventional PFAS-removal technology for water are (i) the poor performance with some PFAS types coupled with the limited ability to further optimize binding via chemical modification, (ii) the slow adsorption kinetics due to the highly porous scaffold, and (iii) the easy fouling with other organic matter coupled with costly regeneration.

Due to the GAC's limitations, several alternative adsorbents have been recently investigated. One example is an anion-exchange (AE) resin, which is often formed from crosslinked polystyrene beads containing cationic functional groups (e.g., —NR₃⁺). Both the surface and internal sites are functionalized, so AE resins exhibit faster adsorption kinetics compared to GAC. In addition, AE resins tend to have more affinity for short-chain PFAS than GAC because of the strong electrostatic interactions between the ionic groups on the resin and PFAS. However, AE resins exhibit limited adsorption of zwitterionic, cationic, and nonionic PFAS. Cation exchange resins (functionalized with anionic —SO₃⁻ groups) were recently evaluated and found to have poor adsorption of anionic and nonionic PFAS, and only modest removal of two zwitterionic PFAS. Such resins are expensive and/or have involved manufacturing process: Unfunctionalized styrene monomer, for example, must be functionalized and then copolymerized with divinylbenzene to make the resin. Moreover, styrene is sourced from oil as a non-renewable resource.

Other adsorbents include the crosslinked polymers containing β-cyclodextrin (β-CD) units. The crosslinkers contain functional groups (e.g., cations and anions) which enhance adsorption via intermolecular interactions (e.g., electrostatic interactions). The highly porous and positively charged β-CD polymers exhibit both fast adsorption kinetics and near complete removal of anionic PFAS. Similarly, the β-CD polymers with negative surface charge exhibited rapid removal of zwitterionic PFAS. However, β-CD adsorbents show variable removal of nonionic PFAS and have not yet been characterized for cationic PFAS. As such, there remains a continuing need for low-cost materials for rapid and robust adsorption of all PFAS derivatives under environmentally realistic and relevant concentrations.

### SUMMARY

In an aspect, the disclosure relates to a cationic-modified wood pulp (or other cellulosic substrate more generally) comprising: a (wood pulp) cellulosic backbone; and a plurality of cationic groups each of which is attached to the cellulosic backbone via a corresponding linking group containing 1 to 6 carbon atoms.

Various refinements of the cationic-modified wood pulp or cellulosic substrate are possible.

In a refinement, the cationic group comprises an ammonium group.

In a refinement, the linking group comprises an ether reaction product between an epoxide-functional cationic group and an original hydroxyl group of the cellulosic backbone.

In a refinement, the cationic-modified wood pulp is free from functionalizing groups other than the cationic groups, for example being free from anionic or other groups not present in the original, unmodified wood pulp.

In a refinement, the cationic groups are present in an amount in a range of 0.1 mmol to 8 mmol cationic group per gram of cationic-modified wood pulp.

In a refinement, the cationic groups are present in an amount in a range of 0.01 to 1 cationic groups per cellulosic backbone repeat unit.

In a refinement, the cationic groups are present in an amount in a range of 0.02 g to 0.5 g cationic group per gram of cellulosic backbone.

In an aspect, the disclosure relates to a anionic-modified wood pulp (or other cellulosic substrate more generally) comprising: a (wood pulp) cellulosic backbone; and a plurality of anionic groups each of which is attached to the cellulosic backbone either (i) directly or (ii) via a corresponding linking group containing 1 to 6 carbon atoms.

Various refinements of the anionic-modified wood pulp or cellulosic substrate are possible.

In a refinement, the anionic group comprises a sulfonate group.

In a refinement, the linking group is present and comprises an ether reaction product between a epoxide-functional anionic group and a hydroxyl group of the cellulosic backbone.

In a refinement, the anionic-modified wood pulp is free from functionalizing groups other than the anionic groups, for example being free from cationic or other groups not present in the original, unmodified wood pulp.

In a refinement, the anionic groups are present in an amount in a range of 0.1 mmol to 8 mmol anionic group per gram of anionic-modified wood pulp.

In a refinement, the anionic groups are present in an amount in a range of 0.01 to 1 anionic groups per cellulosic backbone repeat unit.

In a refinement, the anionic groups are present in an amount in a range of 0.02 g to 0.5 g anionic group per gram of cellulosic backbone.

Various refinements of the modified wood pulp or cellulosic substrate are possible, for example being generally applicable to cationic-modified wood pulp, anionic-modified wood pulp, etc.

In a refinement, the cellulosic backbone is derived from a wood pulp selected from the group consisting of softwood wood pulp, bamboo wood pulp, hardwood wood pulp, and combinations thereof; and/or the cellulosic backbone has an amorphous content in a range of 30% to 70%.

In a refinement, the modified wood pulp is in the form of fibers.

In a refinement, the modified wood pulp is in the form of granules.

In an aspect, the disclosure relates to a method for treating water or other liquid medium contaminated with a perfluoroalkyl substance, the method comprising: providing a contaminated water comprising (i) water and (ii) a perfluoroalkyl substance (PFAS) in the water (e.g., dissolved or dispersed therein); and contacting the contaminated water with a modified wood pulp according to any of the variously disclosed embodiments, refinements, etc. (e.g., a cationic-modified wood pulp, an anionic-modified wood pulp) for a time sufficient to adsorb at least a portion of the PFAS from the contaminated water, thereby forming (i) a treated water having a reduced PFAS content and (ii) a loaded wood pulp comprising the modified wood pulp and adsorbed PFAS thereon.

Various refinements of the method for treating water or other liquid medium contaminated with PFAS are possible.

In a refinement, the PFAS has 4 to 20 perfluorinated carbon atoms; and the PFAS has at least one of an anionic group (e.g., an anionic PFAS) and/or a cationic group (e.g., a cationic PFAS).

In a refinement, the modified wood pulp comprises a cationic-modified wood pulp; the PFAS comprises an anionic PFAS; and the loaded wood pulp comprises the cationic-modified wood pulp and adsorbed anionic PFAS thereon.

In a refinement, the modified wood pulp comprises an anionic-modified wood pulp; the PFAS comprises a cationic PFAS; and the loaded wood pulp comprises the anionic-modified wood pulp and adsorbed cationic PFAS thereon.

In a refinement, the treated water has a PFAS concentration that is 20% or less than that of the contaminated water.

In a refinement, the method comprises contacting the contaminated water with the modified wood pulp for at least 5 sec.

In a refinement, the modified wood pulp has an adsorption capacity in a range of 500 to 1000 mg PFAS/g modified wood pulp.

In a refinement, the method comprises contacting the contaminated water with the modified wood pulp as a batch process or a continuous process.

In a refinement, the PFAS is present in the contaminated water at a concentration in a range of 1 ng/L to 1 mg/L.

In a refinement, the contaminated water has a pH value in a range of 5 to 9.

In a refinement, the contaminated water further comprises sodium chloride at a concentration in a range of 0 to 100 mg/L.

In a refinement, the contaminated water further comprises a natural organic matter (NOM) component selected from the group consisting of humic acids, fulvic acids, humins, and combinations thereof.

In a refinement, the method further comprises treating the loaded wood pulp to degrade the adsorbed PFAS thereon.

While the disclosed compounds, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE FIGURES

FIG. 1 illustrates a representative formation reaction and corresponding structure for a cationic-modified wood pulp according to the disclosure, including (A) a generic structure, and (B) an illustration of unmodified and modified repeat units.

FIG. 2 illustrates a representative formation reaction and corresponding structure for an anionic-modified wood pulp according to the disclosure.

FIG. 3 illustrates a method for treating contaminated water in a batch operation using modified wood pulp according to the disclosure.

FIG. 4 illustrates a method for treating contaminated water in a continuous operation using modified wood pulp according to the disclosure.

FIG. 5 illustrates chemical structures of representative anionic and cationic perfluoroalkyl substances (PFASs).

FIG. 6 is a graph illustrating the effect of QWP charge density on PFOS (bottom values at charge densities at/below 1 mmol/g) and PFOA (top values at charge densities at/below 1 mmol/g) on adsorption percent. Initial concentrations are as follows: [QWP]=50.0 mg/L, [PFOS]₀=4.2 mg/L, and [PFOA]₀=3.9 mg/L.

FIG. 7 is a graph illustrating the effect of adsorption time on adsorption capacity (qt) for PFOS (top) and PFOA (bottom) for QWP1.5. Initial concentrations are as follows: [QWP1.5]=10.0 mg/L, [PFOS]₀=3.5 mg/L, and [PFOA]₀=3.9 mg/L.

FIG. 8 includes a graph (left) illustrated PFAS adsorption (%) on QWP1.5 with 30 s (white) and 60 min (gray) of contact time as well as chemical structures (right) for the PFAS compounds in the text mixture. Initial concentrations are as follows: [QWP1.5]=10.0 mg/L, [PFAS]₀=˜2.5 μg/L.

### DETAILED DESCRIPTION

The disclosure generally relates to functionalized wood pulp (WP) fibers and their use as low-cost and biorenewable adsorbents for PFAS-contaminated groundwater. The functionalized WP fibers are able to quickly adsorb and remove PFAS from contaminated water with a high degree of adsorption efficiency (e.g., expressed as a fraction of inlet PFAS removed). The examples described in more detail below illustrate that anionic PFASs were quickly adsorbed (e.g., contact times <30 s) onto WP functionalized with cationic groups under environmentally relevant concentrations and conditions. While anionic PFAS derivatives are most prevalent, groundwater sources are also contaminated with cationic, zwitterionic, and non-ionic PFAS from aqueous film-forming foam (AFFF) formulations. In fact, the variety of PFAS compounds found within AFFF makes remediation efforts daunting. In various embodiments, the WP fibers are functionalized or modified with a (pendant) functional group that is complementary to a corresponding functional group on particular PFASs targeted for removal/remediation, thereby enhancing the intermolecular interactions involved in adsorption. For example, grafting anionic functional groups onto WP can enhance adsorption of cationic PFAS (i.e., analogous to the grafting of cationic functional groups onto WP to enhance adsorption of anionic PFAS as in the examples). Similarly, higher functional group densities on the functionalized WP (e.g., up to about 1 functional group/cellulose repeat unit) can provide adsorbent materials higher adsorption capacities for settings where adsorption involves a 1:1 binding interaction between the functional group on the WP and the target PFAS molecule. The examples further illustrate that PFAS adsorption using the functionalized WP is efficient over range conditions representative of typical contaminated groundwater (e.g., varying pH levels or salt identity/concentration). The functionalized WP can be used in a variety of forms, for example as fibers or granules, and can be used in batch or continuous adsorption processes, for example in an agitated slurry reactor/vessel for batch operation or in a packed-bed filtration system for continuous operation.

The functionalized WP is simple to manufacture, ready-to-use post-functionalization, and has a low environmental impact/footprint. WP is inexpensive ($1/kg), biorenewable, and biodegradable. WP is produced during paper-making, and with ˜400 paper-making facilities in the US producing ˜9 million tons of WP each year, it is widely available. The disclosed functionalized WPs provide tailored adsorbents for different types of PFAS by grafting complementary groups onto WP to maximize their affinity. Thus, the disclosure provides low-cost adsorbents that can be used to efficiently remediate a diverse range of PFAS with the potential to improve groundwater quality for millions of US residents.

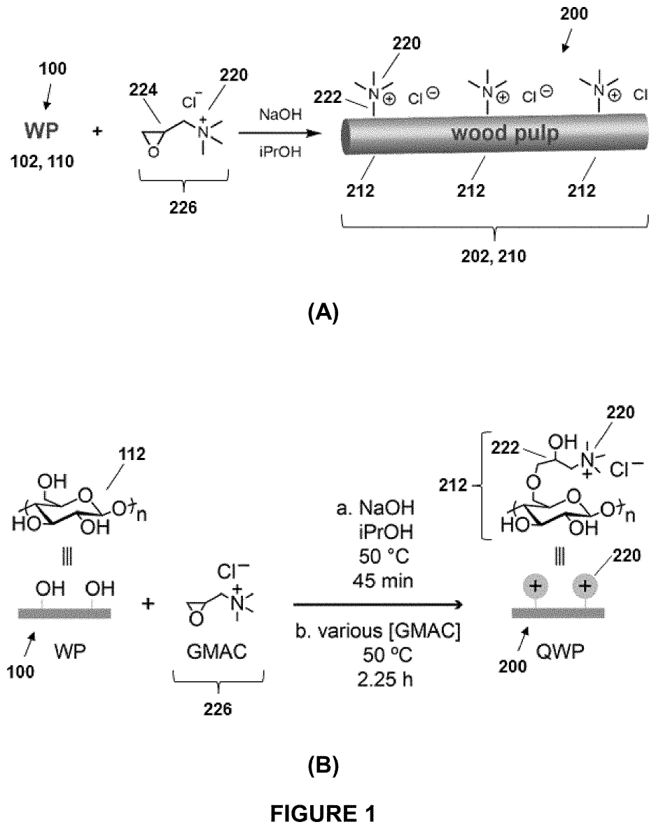

FIG. 1 illustrates a cationic-modified wood pulp (or other cellulosic substrate) 200 according to the disclosure. The cationic-modified wood pulp 200 generally includes a cellulosic backbone 210 and a plurality of cationic groups 220 covalently bound or otherwise attached thereto. Each cationic group 220 is attached to the cellulosic backbone 210 via a corresponding linking group 222 containing 1 to 6 or 1 to 12 carbon atoms. The cellulosic backbone 210 is generally a linear polysaccharide containing a plurality of beta(1→4) linked D-glucose units, for example derived from wood pulp and having been reacted at various hydroxyl group positions originally present in the cellulosic substrate for attachment of the cationic groups 220. The cationic groups 220 are distributed along the length of the cellulosic backbone 210, generally as pendant groups that are linked to the backbone 210 via a plurality of linking groups 222. For example, one cationic group 220 is bound to one cationic-modified glucose repeat unit 212 in the backbone 210 by one corresponding linking group 222. The linking groups 222 can be attached to the backbone 210 via ether linkages or ester linkages, for example resulting from reaction between (1) cellulosic hydroxyl groups in an original (unmodified) wood pulp 100 having an (unmodified) cellulosic backbone 110 with glucose repeat units 112 (e.g., at the C6 position in the unmodified repeat units 112) and (2) an epoxide- (or glycidyl-) functional cationic group 220 or carboxyl-functional functional cationic group 220, respectively. The linking group 222 can contain 1, 2, 3, 4, 5, 6, 7, 8, 9, 10, 11, or 12 carbon atoms, for example as a substituted or unsubstituted alkylene group linking the cationic group 220 and the ether or ester oxygen atom on the backbone 210. The linking group 222 can be substituted with a hydroxyl group (e.g., as a result of epoxide ring opening and ether link formation), with a carbonyl oxygen (e.g., as a result of condensation and ester link formation), and/or with fluorine atoms (e.g., including one or more perfluorinated carbons in the linking group 222).

In various embodiments, the cationic group 220 can include one or more of an ammonium group, an amino group, and a phosphonium group. In some embodiments, the cationic-modified wood pulp 200 includes only a single type of cationic group 220, while in other embodiments the cationic-modified wood pulp 200 includes multiple different types of cationic groups 220 (e.g., two different types of ammonium groups, one type of ammonium group and one type of phosphonium group). In some embodiments, the cationic-modified wood pulp 200 is free from functionalizing groups other than the cationic groups 220, for example being free from anionic or other groups not present in the original, unmodified wood pulp 100.

The ammonium group can be a primary, secondary, tertiary, or quaternary ammonium group. For example, the ammonium group can be represented by —(NR¹R²R³)⁺, where the dash represents the bond to the linking group 222. R¹, R², and R³ independently can be hydrogen (H) or a hydrocarbon group having at least 1, 2, 3, or 4 and/or up to 2, 3, 4, 6, 8, 10, or 12 carbon atoms, for example a C₁-C₄ or C₁-C₁₂ substituted or unsubstituted alkyl group and/or aromatic group. In an embodiment, the cationic group 220 is a quaternary ammonium group such that R¹, R², and R³ are other than H. In an embodiment, the cationic group 220 is a trimethyl ammonium group (—(N(CH₃)₃)⁺). In an embodiment, R¹, R², and/or R³ independently can include one or more perfluorinated carbon atoms, for example in a perfluorinated alkyl or aromatic group. The counter ion for the cationic group 220 is not particularly limited, but it suitably can be a halide anion such as chloride. The amino or amine group can be a primary, secondary, or tertiary amino group. For example, the amino group can be represented by —(NR¹R²), where the dash represents the bond to the linking group 222. R¹ and R² independently can be selected from the same options as described for the ammonium group. In an embodiment, the cationic group 220 is a tertiary amino group such that R¹ and R² are other than H. The amino group can function as a cationic group in an aqueous environment by dissociating water to form a corresponding —(NR¹R²H)⁺ ammonium group and hydroxide ions in the aqueous environment. The phosphonium group can be a primary, secondary, tertiary, or quaternary phosphonium group. For example, the ammonium group can be represented by —(PR¹R²R³)⁺, where the dash represents the bond to the linking group 222. R¹, R², R³, and the counter ion independently can be selected from the same options as described for the ammonium group.

In an embodiment and as described above, the linking groups 222 can be attached to the backbone 210 via ether linkages. For example, the linking group 222 and cationic group 220 can be attached to the cellulosic backbone 210 by reaction with a functionalizing reactant 226 of the general form A-B, where A is a linking precursor 224 including an epoxide- (or glycidyl-) functional group and B includes the cationic group 220 (e.g., A-(NR¹R²R³)⁺ for an ammonium cationic group). The epoxide-functional group A generally includes the same number of carbon atoms as the corresponding linking group 222. For example, a glycidyl trimethylammonium chloride (GMAC) functionalizing reactant 226 has a 3-carbon epoxide group linked to a trimethylammonium cationic group 220. Upon reaction with a hydroxyl group that is originally present in a glucose repeat unit 112 along the cellulosic backbone 110 prior to modification, a corresponding 3-carbon linking group 222 is formed with an ether link to the cellulosic backbone 210 at one end of the linking group 222, a pendant hydroxyl group resulting from epoxide ring-opening, and the trimethylammonium cationic group 220 at the opposing end of the linking group 222. In other embodiments, the linking groups 222 can be attached to the backbone 210 via other linkages such as ester, urethane/carbamate, silyl condensation, etc. resulting from reaction with the original hydroxyl groups. For example, in the general form A-B above for the functionalizing reactant 226, the linking precursor 224 can include a carboxylic group to form a corresponding ester linkage (C(═O)O), an isocyanate group to form a corresponding urethane or carbamate linkage (NC(═O)O), or a hydrolysable silyl group to form a corresponding silyl condensation (Si—O—C) linkage.

The degree of functionalization of the cationic-modified wood pulp 200 can be alternatively expressed on one or more of a mol/wt, mol/mol, or wt/wt basis. Higher relative degrees of functionalization can improve the resulting adsorption properties. Selection of a particular functionalizing reactant 226 can be used to control the eventual degree of functionalization, for example where larger or more hydrophobic groups in the cationic group 220 (e.g., R¹, R², R³) and/or linking group 222 can limit water solubility and promote higher degrees of functionalization.

In some embodiments, the cationic groups 220 can be present in an amount in a range of 0.1 mmol to 8 mmol cationic group per gram of cationic-modified wood pulp 200 (dry weight basis), thus reflecting the total weight of the original (unmodified) wood pulp 100 combined with the converted amount of functionalizing reactant 226 (e.g., less any lost water or other byproduct for a condensation or other linking reaction). For example, the cationic groups 220 can be present in an amount of at least 0.1, 0.2, 0.5, 0.7, 1, 1.2, 1.5, 2, 2.5, 3, 4, or 5 mmol and/or up to 1, 2, 3, 4, 5, 6, 7, or 8 mmol cationic group per gram of cationic-modified wood pulp.

In some embodiments, the cationic groups 220 can be present in an amount in a range of 0.01 to 1 cationic groups 220 per cellulosic backbone repeat unit 212. For example, the cationic groups 220 can be present in an amount of at least 0.01, 0.02, 0.05, 0.1, 0.15, 0.2, 0.25, 0.3, 0.4, or 0.5 and/or up to 0.1, 0.2, 0.3, 0.4, 0.5, 0.6, 0.7, 0.8, or 1 cationic groups per cellulosic backbone repeat unit.

In some embodiments, the cationic groups 220 can be present in an amount in a range of 0.02 g to 0.5 g cationic group 220 per gram of cellulosic backbone 210 (dry weight basis), thus reflecting the weight of the cationic group (e.g., —(NR¹R²R³)⁺, but without the linking group or counter ion) relative to the cellulosic backbone. For example, the cationic groups 220 can be present in an amount of at least 0.02, 0.05, 0.1, 0.15, 0.2, 0.25, or 0.3 g and/or up to 0.1, 0.2, 0.3, 0.4, or 0.5 g cationic group per gram of cellulosic backbone. In some embodiments, the combined amount of functionalizing groups can be present in an amount in a range of 0.02 g to 5 g functionalizing groups per gram of cellulosic backbone 210 (dry weight basis), thus reflecting the combined weight of the cationic group, linking group, and counter ion relative to the cellulosic backbone. For example, the combined amount of functionalizing groups can be present in an amount of at least 0.02, 0.05, 0.1, 0.15, 0.2, 0.25, 0.3, 0.5, 0.7, or 1 g and/or up to 0.1, 0.2, 0.5, 0.7, 1, 1.5, 2, 3, 4, or 5 g functionalizing groups per gram of cellulosic backbone.

FIG. 1 also illustrates a representative process for forming a cationic-modified wood pulp 200 for the specific example of grafting quaternary ammonium (e.g., —NMe₃⁺) functional groups onto the wood pulp, which can drive anionic PFAS adsorption via strong electrostatic interactions. Quaternary amines are permanent cations that are invariant to any changes in water pH levels. Such cationic-functionalized wood pulp derivatives can be prepared via reaction of the wood pulp with glycidyl trimethyl ammonium chloride under basic conditions. The cationic-modified wood pulp 200 can be prepared with different charge or functionalization densities (e.g., mmol —NMe₃⁺/g wood pulp) by varying the epoxide reactant concentration, due to its bimolecular reaction mechanism. Cellulose is a linear polymer consisting of anhydro-D-glucopyranose units and functionalization is usually selective for the primary alcohol.

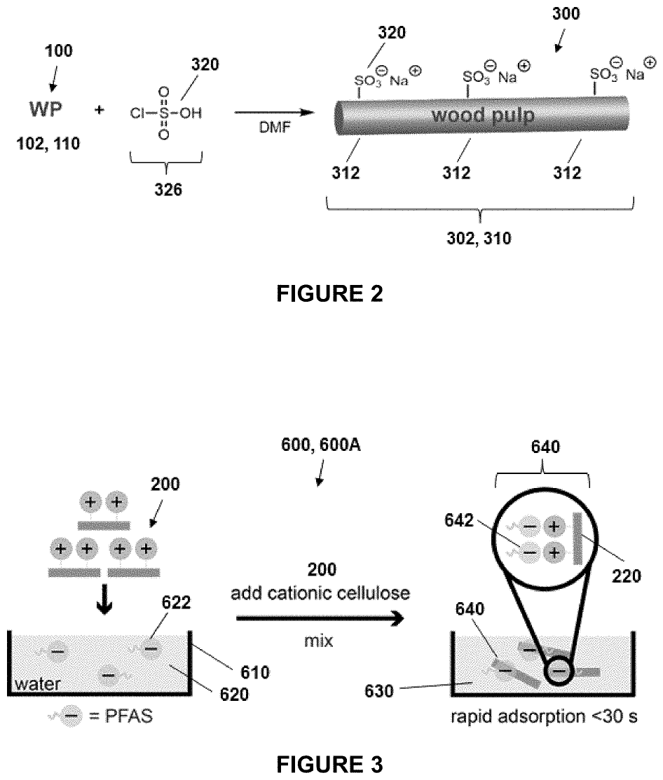

FIG. 2 illustrates an anionic-modified wood pulp (or other cellulosic substrate) 300 according to the disclosure. The anionic-modified wood pulp 300 generally includes a cellulosic backbone 310 and a plurality of anionic groups 320 covalently bound or otherwise attached thereto. In various embodiments, each anionic group 320 can be attached to the cellulosic backbone 310 either directly, or via a corresponding linking group (not shown) containing 1 to 6 carbon atoms. Analogous to the cellulosic backbone 210 in FIG. 1, the cellulosic backbone 310 is generally a linear polysaccharide containing a plurality of beta(1→4) linked D-glucose units, for example derived from wood pulp and having been reacted at various hydroxyl group positions originally present in the cellulosic substrate for attachment of the anionic groups 320. The anionic groups 320 are distributed along the length of the cellulosic backbone 310, generally as pendant groups that are linked to the backbone 310. In some embodiments, the anionic groups 320 are attached directly to the cellulosic backbone 310, for example via an oxygen atom as a reaction product between (1) hydroxyl groups (e.g., at the C6 and/or C2 position) in an original (unmodified) wood pulp 100 having an (unmodified) cellulosic backbone 110 with glucose repeat units 112 and (2) a functionalizing reactant 326 such as a halo-functional anionic group 320 (e.g., a chlorosulfonic group such as in chlorosulfonic acid or a corresponding chlorosulfonate salt). For example, a pendant cellulosic hydroxyl group —OH can react with chlorosulfonic acid (Cl—SO₃H) to form a corresponding anionic group —OSO₃⁻ attached to the cellulosic backbone (e.g., in acid form with a hydrogen atom or salt form with a sodium or other counter ion). In some embodiments, the anionic groups 320 are attached (indirectly) to the cellulosic backbone 310 via a plurality of linking groups (not shown, but analogous to the linking groups 222). For example, one anionic group 320 is bound to one anionic-modified glucose repeat unit 312 in the backbone 310 by one corresponding linking group. The linking groups can be attached to the backbone 310 via ether linkages, ester linkages, urethane or carbamate linkages, silyl condensation linkages, etc. using the same linking groups, reactive functionalizing groups, etc. as described above for the cationic-modified wood pulp 200.

In various embodiments, the anionic group 320 can include one or more of a sulfonate group and a carboxylate group. In some embodiments, the anionic-modified wood pulp 300 includes only a single type of anionic group 320, while in other embodiments the anionic-modified wood pulp 300 includes multiple different types of anionic groups 320 (e.g., two different types of sulfonate groups, one type of sulfonate group and one type of carboxylate group). In some embodiments, the anionic-modified wood pulp 300 is free from functionalizing groups other than the anionic groups 320, for example being free from cationic or other groups not present in the original, unmodified wood pulp 100.

The sulfonate group can be represented by —(SO₃)⁻, where the dash represents the bond to the carbon backbone 310 (e.g., for a direct attachment) or to the linking group (e.g., for an indirect attachment). The carboxylate group can be represented by —(C(═O)O)⁻, where the dash represents the bond to the carbon backbone 310 (e.g., for a direct attachment) or to the linking group (e.g., for an indirect attachment). The counter ion for the anionic group is not particularly limited, but it suitably can be a metal cation, for example an alkali metal cation such as a lithium, sodium, or potassium ion. In some embodiments, the anionic group can be in acid form (—(SO₃H) or —(C(═O)OH), which can then deprotonate in an aqueous environment to provide the anionic moiety —(SO₃)⁻ or —(C(═O)O)⁻.

In an embodiment and as described above, the linking groups can be included for attachment of the anionic groups 320 to the backbone 310 via ether linkages or other linkages. For example, the linking group and anionic group 320 can be attached to the cellulosic backbone 310 by reaction with a functionalizing reactant of the general form A-B, where A is a linking precursor including an epoxide- (or glycidyl-) functional group and B includes the anionic group 320 (e.g., A-(SO₃H) or A-(SO₃)⁻ for a sulfonate anionic group). The epoxide-functional group A generally includes the same number of carbon atoms as the corresponding linking group and is otherwise analogous to the precursor 224 described above. In other embodiments, the linking groups can be attached to the backbone 310 via other linkages such as ester, urethane/carbamate, silyl condensation, etc. resulting from reaction with the original hydroxyl groups. For example, in the general form A-B above for the functionalizing reactant, the linking precursor can include a carboxylic group to form a corresponding ester linkage (C(═O)O), an isocyanate group to form a corresponding urethane or carbamate linkage (NC(═O)O), or a hydrolysable silyl group to form a corresponding silyl condensation (Si—O—C) linkage.

The degree of functionalization of the anionic-modified wood pulp 300 can be alternatively expressed on one or more of a mol/wt, mol/mol, or wt/wt basis. Higher relative degrees of functionalization can improve the resulting adsorption properties. Selection of a particular functionalizing reactant 326 can be used to control the eventual degree of functionalization, for example where larger or more hydrophobic groups in the functionalizing reactant (e.g., linking group) can limit water solubility and promote higher degrees of functionalization.

In some embodiments, the anionic groups 320 can be present in an amount in a range of 0.1 mmol to 8 mmol anionic group per gram of anionic-modified wood pulp 300 (dry weight basis), thus reflecting the total weight of the original (unmodified) wood pulp 100 combined with the converted amount of functionalizing reactant 326 (e.g., less any lost water or other byproduct for a condensation or other linking reaction). For example, the anionic groups 320 can be present in an amount of at least 0.1, 0.2, 0.5, 0.7, 1, 1.2, 1.5, 2, 2.5, 3, 4, or 5 mmol and/or up to 1, 2, 3, 4, 5, 6, 7, or 8 mmol anionic group per gram of anionic-modified wood pulp.

In some embodiments, the anionic groups 320 can be present in an amount in a range of 0.01 to 1 anionic groups 320 per cellulosic backbone repeat unit 312. For example, the anionic groups 220 can be present in an amount of at least 0.01, 0.02, 0.05, 0.1, 0.15, 0.2, 0.25, 0.3, 0.4, or 0.5 and/or up to 0.1, 0.2, 0.3, 0.4, 0.5, 0.6, 0.7, 0.8, or 1 anionic groups per cellulosic backbone repeat unit.

In some embodiments, the anionic groups 320 can be present in an amount in a range of 0.02 g to 0.5 g anionic group 320 per gram of cellulosic backbone 310 (dry weight basis), thus reflecting the weight of the anionic group (e.g., —(SO₃)⁻, but without any linking group or counter ion) relative to the cellulosic backbone. For example, the anionic groups 320 can be present in an amount of at least 0.02, 0.05, 0.1, 0.15, 0.2, 0.25, or 0.3 g and/or up to 0.1, 0.2, 0.3, 0.4, or 0.5 g anionic group per gram of cellulosic backbone. In some embodiments, the combined amount of functionalizing groups can be present in an amount in a range of 0.02 g to 5 g functionalizing groups per gram of cellulosic backbone 310 (dry weight basis), thus reflecting the combined weight of the anionic group, linking group (if present), and counter ion relative to the cellulosic backbone. For example, the combined amount of functionalizing groups can be present in an amount of at least 0.02, 0.05, 0.1, 0.15, 0.2, 0.25, 0.3, 0.5, 0.7, or 1 g and/or up to 0.1, 0.2, 0.5, 0.7, 1, 1.5, 2, 3, 4, or 5 g functionalizing groups per gram of cellulosic backbone.

FIG. 2 also illustrates a representative process for forming an anionic-modified wood pulp 300 for the specific example of grafting sulfate (—SO₃⁻) functional groups functional groups onto the wood pulp to drive adsorption of cationic PFAS via electrostatic interactions. The estimated pKa of sulfonic acid is ˜2, meaning that the sulfate group should remain anionic at typical groundwater pH levels. The anionic-modified wood pulp 300 can be synthesized using chlorosulfonic acid in dimethylformamide, followed by neutralization with sodium hydroxide to form the corresponding sodium sulfonate salt groups. The modified wood pulp 300 can be prepared with different charge or functionalization densities (mmol —SO₃⁻/g wood pulp) by varying the chlorosulfonic acid concentration due to its bimolecular reaction mechanism.

The wood pulp 100 used to form the corresponding cationic-modified wood pulp 200 or anionic-modified wood pulp 300 is not particularly limited and can include wood pulp and/or corresponding cellulosic backbones derived from one or more of softwood wood pulp, bamboo wood pulp, and hardwood wood pulp. The wood pulp is generally a cellulosic fibrous material obtained by separation from a wood source such as a softwood, bamboo, or a hardwood, for example using any of a variety of mechanical and/or chemical pulping processes known in the art. Example pulping processes include one or more of mechanical, thermomechanical, chemical, kraft, organosolv, etc. The wood pulp generally includes the cellulose portions of the original wood material, but at least some if not most or substantially all of the lignin, hemicellulose, proteins, extractives, inorganic and/or other components from the original wood material have been removed from the wood pulp product. For example, the wood pulp (e.g., the wood pulp 100 prior to modification) can include at least 70, 80, 90, or 95 wt. % and/or up to 89, 90, 95, 98, 99, or 100 wt. % cellulose (dry weight) corresponding to the original cellulosic backbone 110 and the eventual modified cellulosic backbone 210 or 310. In some embodiments, the wood pulp can include not more than 10, 5, 2, or 1 wt. % and/or at least 2, 1, or 0.1 wt. % lignin (dry weight). In some embodiments, the wood pulp can include not more than 20, 15, 10, 5, 2, or 1 wt. % and/or at least 5, 2, 1, or 0.1 wt. % hemicellulose (dry weight), for example including xylans, (galacto)glucomannans, or both. The original and modified wood pulp 100, 200, 300 and corresponding cellulosic backbone 110, 210, 310 generally has both amorphous and crystalline components. In an embodiment, the cellulosic backbone (or wood pulp) can have an amorphous content of 30-70% (e.g., on a weight or number basis), for example at least 30, 40, 45, or 50% and/or up to 50, 55, 60, or 70%. Similarly, the cellulosic backbone (or wood pulp) can have a crystalline content of 30-70% (e.g., on a weight or number basis), for example at least 30, 40, 45, or 50%, up to 50, 55, 60, or 70%, and/or as the balance relative to the amorphous content. The original and modified wood pulp 100, 200, 300 and corresponding cellulosic backbone 110, 210, 310 can have any suitable degree of polymerization (DP) (or an equivalent molecular weight (MW) based on the glucose repeat unit), for example in a range of 100 to 30000 (e.g., at least 100, 200, 500, 1000, or 5000 and/or up to 5000, 10000, 15000, 20000, or 30000). The foregoing ranges can represent a span of a distribution (e.g., 1%/99%, 5%/95%, or 10%/90% cut points in a cumulative distribution) or an range in which the average DP lies, for example a number- or weight-average DP.

The wood pulp as originally formed by the pulping process generally in the form of fibers. The fibers generally have a distribution of sizes, which can depend on pulping method(s) used and the source of wood material. In various embodiments, the fibers can have a diameter (or width/thickness) in a range of 1 μm to 100 μm, for example at least 1, 2, 3, 5, 10, 15, 20, 30, 40, or 50 μm and/or up to 10, 20, 30, 40, 50, 60, 70, 80, 90, or 100 μm. Alternatively or additionally the fibers can have a length in a range of 0.5 mm to 10 mm, for example at least 0.5, 1, 1.5, 2, or 3 mm and/or up to 3, 4, 5, 6, 7, 8, 9, or 10 mm. In some embodiments, the fibers as originally formed by the pulping process can be further processed using a size-reduction technique such as grinding, milling, etc. to provide the wood pulp in a granular form. Such granules can be used in their size-reduced form, or they can be agglomerated or bound into a larger aggregates, for example using a polymeric or other binder, thus providing a quasi-spherical shape having a desired diameter (e.g., an effective or equivalent spherical diameter). In various embodiments, the granules (either individual or aggregated) can have a diameter in a range of 10 μm to 100 μm or 10 μm to 10 mm, for example at least 10, 20, 50, 100, 200, 500, 1000, or 2000 μm and/or up to 40, 80, 150, 250, 400, 600, 800, 1000, 2000, 3000, 5000, or 10000 mm. The foregoing size (e.g., length, diameter, width, etc.) ranges for fibers and granules can represent a span of a distribution (e.g., 1%/99%, 5%/95%, or 10%/90% cut points in a cumulative size distribution) or an range in which the average size lies, for example a number-, weight-, or volume-average size.

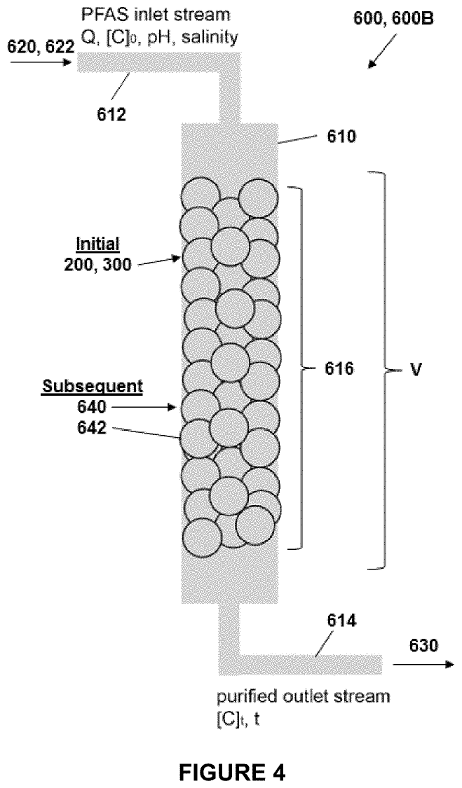

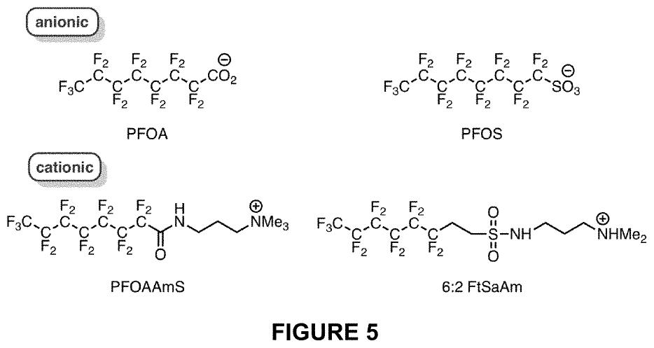

FIGS. 3 and 4 illustrate methods 600 for treating water or other liquid medium contaminated with a perfluoroalkyl substance (PFAS), for example to remove a PFAS contaminant therefrom or otherwise remediate the contaminated water or liquid. FIG. 3 illustrates a batch process 600A and FIG. 4 illustrates a continuous process 600B within the generic methods 600 described herein. FIG. 5 illustrates chemical structures of representative anionic and cationic PFAS contaminants 622 to be removed or treated by the methods 600. An initial or inlet contaminated water 620 generally includes water (e.g., an aqueous medium such as containing at least 90, 95, 98, or 99 wt. % water) and one or more PFAS contaminants 622 in the water or other liquid medium, for example being dissolved or dispersed therein. The contaminated water 620 can be introduced into an adsorption vessel 610, for example into a batch vessel (FIG. 3) or into a continuous-flow vessel via an inlet 612 (FIG. 4). The contaminated water 620 is then contacted with a modified wood pulp 200, 300 for a time sufficient to adsorb at least a portion of the PFAS 622 from the contaminated water 620, thereby forming (i) a treated water 630 having a reduced PFAS content and (ii) a loaded wood pulp 640, which includes the modified wood pulp 200, 300 and adsorbed PFAS 642 thereon. The modified wood pulp 200, 300 can be introduced into an adsorption vessel 610, for example into the batch vessel containing the contaminated water 620 (FIG. 3) or as a packing 616 in the continuous-flow vessel (FIG. 4). The temperature and pressure conditions for the contacting/adsorption process are not particularly limited, but ambient temperature (e.g., 20-30° C.) and pressure (e.g., atmospheric) are suitable. After sufficient contact time for the desired level of adsorption, the treated water 630 can be withdrawn or removed from the adsorption vessel 610, for example from the batch vessel (FIG. 3) or from the continuous-flow vessel via an inlet 614 (FIG. 4).

The treated water 630 having a reduced PFAS content can include water that is free or essentially free from PFAS if essentially all of the original PFAS 622 from the contaminated water 620 has been adsorbed by the modified wood pulp 200, 300. In other cases, the treated water 630 can include some remaining PFAS, albeit at a lower concentration relative to the initial value in the contaminated water 620.

The loaded wood pulp 640 contains at least some PFAS 642 adsorbed thereon, for example via electrostatic or ionic interactions between the cationic groups or anionic groups 220, 320 of the modified wood pulp 200, 300 and corresponding anionic groups or cationic groups, respectively, of a particular PFAS adsorbate 642. In some cases, the loaded wood pulp 640 might still contain some free cationic groups or anionic groups 220, 320 (i.e., it is only partially saturated with PFAS adsorbates 642) and can be used in a subsequent treatment process to remove additional PFAS 622 from additional contaminated water 620. In some cases, the loaded wood pulp 640 might no longer contain free cationic groups or anionic groups 220, 320 (i.e., it is spent or essentially completely saturated with PFAS adsorbates 642) and no longer has any substantial capacity to remove additional PFAS 622 from additional contaminated water 620. Such spent wood pulp can then be replaced with fresh modified wood pulp 200, 300 before further water treatment.

A given PFAS can include 4 to 20 perfluorinated carbon atoms, for example in linear or branched perfluoroalkyl structures. Perfluorinated carbon atoms can include CF₃ (e.g., primary carbon at the end of a linear or branched alkyl segment), CF₂ (e.g., secondary carbon along the length of a linear or branched alkyl segment), and CF (e.g., tertiary carbon at a branch point in a branched alkyl segment). In some embodiments, a given PFAS can be an anionic PFAS, containing at least one anionic group such as sulfonate (SO₃⁻) or carboxylate (C(═O)O—), for example in acid or metal salt form (e.g., alkali metal salt such as sodium or potassium). In some embodiments, a given PFAS can be a cationic PFAS, containing at least one cationic group such as ammonium ((NR¹R²R³)⁺, with the options for the R¹, R², and R³ groups and counter ions as defined above the cationic-modified wood pulp), for example in halide salt form. In various embodiments, a given PFAS, whether anionic, cationic, or otherwise, can include other groups such as amide groups, sulfonamide groups, ether groups, hydroxy groups, and/or (non-fluorinated) alkyl groups or alkylene linking groups containing 1, 2, 3, 4, 5, or 6 carbon atoms. In various embodiments, the contaminated water can include a plurality of different PFASs. Examples of anionic PFAS include Perfluorobutanoic Acid (PFBA), Perfluoropentanoic Acid (PFPeA), 4:2 Fluorotelomer Sulfonic Acid (4:2 FTSA), Perfluorohexanoic Acid (PFHxA), Perfluorobutane Sulfonic Acid (PFBS), Perfluoroheptanoic Acid (PFHpA), Perfluoropentane Sulfonic Acid (PFPeS), 6:2 Fluorotelomer Sulfonic Acid (6:2 FTSA), Perfluorooctanoic Acid (PFOA), Perfluorohexane Sulfonic Acid (PFHxS), Perfluorohexane Sulfonic Acid—Linear (PFHxS-LN), Perfluorohexane Sulfonic Acid—Branched (PFHxS-BR), Perfluorononanoic Acid (PFNA), 8:2 Fluorotelomer Sulfonic Acid (8:2 FTSA), Perfluoroheptane Sulfonic Acid (PFHpS), Perfluorodecanoic Acid (PFDA), N-Methyl Perfluorooctane Sulfonamidoacetic Acid (N-MeFOSAA), N-Ethyl Perfluorooctane Sulfonamidoacetic Acid (EtFOSAA), Perfluorooctane Sulfonic Acid (PFOS), Perfluorooctane Sulfonic Acid—Linear (PFOS-LN), Perfluorooctane Sulfonic Acid—Branched (PFOS-BR), Perfluoroundecanoic Acid (PFUnDA), Perfluorononane Sulfonic Acid (PFNS), Perfluorododecanoic Acid (PFDoDA), Perfluorodecane Sulfonic Acid (PFDS), Perfluorotridecanoic Acid (PFTrDA), Perfluorooctane Sulfonamide (FOSA), Perfluorotetradecanoic Acid (PFTeDA), Undecafluoro-2-methyl-3-oxahexanoic acid (GenX), 10:2-fluorotelomersulfonic acid (10:2 FTS), Perfluorododecanesulfonic acid (PFDoS), Perfluorododecanoic acid (PFDoA), Pedluorohexadecanoic acid (PFHxDA), Pedluorooctadecanoic acid (PFODA), Pedluorotetradecanoic acid (PFTeDA), Pedluorotridecanoic acid (PFTrDA), Pedluoroundecanoic acid (PFUDA), 4,8-dioxa-3H-perfluorononanoic acid (DONA), 9-chlorohexadecafluoro-3-oxanonane-1-sulfonic acid (9Cl—PF3ONS), 11-chloroeicosafluoro-3-oxaundecane-1-sulfonic acid (11Cl-PF3OUdS), Perfluoro(3,4,5,9-tetraoxadecanoic) acid, Perfluoro(3,5,7-trioxaoctanoic) acid, Perluoro(3,5-dioxahexanoic) acid, Perfluoro-2-methoxyacetic acid, Pertluoro-2-methoxyethoxyacetic acid, Perfluoro-3-methoxypropanoic acid, Perfluoro-4-isopropoxybutanoic acid, Perfluoro-4-methoxybutanoic acid, and their corresponding salts. Examples of cationic PFAS include perfluorooctaneamido quaternary ammonium salt (PFOAAmS) and 6:2 fluorotelomer sulfonamido amine (FtSaAm).

The modified wood pulp 200, 300 is generally selected to be complementary to the intended PFAS contaminant 622 in the contaminated water 300. For example, a cationic-modified wood pulp 200 can be use when the contaminated water 300 is known to contain or suspected of containing one or more anionic PFAS contaminants 622. Similarly, an anionic-modified wood pulp 300 can be use when the contaminated water 620 is known to contain or suspected of containing one or more cationic PFAS contaminants 622. In some embodiments, the modified wood pulp includes only cationic-modified wood pulp 200. This can be useful when it is desired to only remove anionic PFAS 622 from the contaminated water 620, for example when the contaminated water 620 contains only anionic PFAS contaminants 622 (e.g., no cationic PFAS or other PFAS without anionic functionality). In some embodiments, the modified wood pulp includes only anionic-modified wood pulp 300. This can be useful when it is desired to only remove cationic PFAS 622 from the contaminated water 620, for example when the contaminated water 620 contains only cationic PFAS contaminants 622 (e.g., no anionic PFAS or other PFAS without cationic functionality). In some embodiments, the modified wood pulp includes both cationic-modified wood pulp 200 and anionic-modified wood pulp 300. This can be useful when it is desired to remove both cationic PFAS and anionic PFAS from the contaminated water 620, for example when the contaminated water 620 contains both anionic and cationic PFAS contaminants 622, or when the contaminated water 620 contains PFAS of unknown/undetermined types (e.g., possibly one or both of anionic and cationic PFAS contaminants). For example, both cationic-modified wood pulp 200 and anionic-modified wood pulp 300 can be added to an adsorption vessel 610, whether for batch operation or continuous-flow operation, such as with different types of modified wood pulp mixed together or in segregated packing areas within a continuous-flow column. In other cases where the contaminated water 620 contains both anionic and cationic PFAS contaminants 622, the contaminated water 620 can be treated in series with different types of modified wood pulp, for example first with cationic-modified wood pulp 200 (only) and then with anionic-modified wood pulp 300 (only) or vice versa.

The modified wood pulp 200, 300 advantageously can provide a relatively high separation or adsorption efficiency for capture and removal of PFAS contaminants 622 from the contaminated water 620. In some embodiments, the treated water 630 has a PFAS concentration that is 50% or less than that of the contaminated water 620. For example the treated water 630 can have a PFAS concentration of not more than 1, 2, 5, 10, 15, 20, 25, 30, 40, or 50% and/or at least 0.01 or 0.1% of the PFAS concentration of the contaminated water 620. Alternatively or additionally, at least 50% of the PFAS contaminant 622 in the contaminated water 620 is removed therefrom and adsorbed by the modified wood pulp 200, 300 as the PFAS adsorbate 642 in the loaded wood pulp 640. For example, at least 50, 60, 70, 80, 85, 90, 95, 98, or 99% and/or up to 70, 80, 90, 95, 98, or 100% of the PFAS contaminant 622 is removed from the contaminated water 620. When the contaminated water 620 contains a plurality of different PFAS contaminants 622, the foregoing ranges for separation/adsorption efficiency can apply collectively to all PFASs initially present (e.g., all anionic PFASs initially present and/or all cationic PFASs initially present), independently to individual PFASs initially present, etc. Different PFAS contaminants 622 can have different separation/adsorption efficiencies for a given modified wood pulp 200, 300, for example where longer-chain PFAS can be adsorbed more efficiently than shorter-chain PFAS in some embodiments.

The modified wood pulp 200, 300 advantageously can provide a relatively high separation or adsorption kinetics for rapid capture and removal of PFAS contaminants 622 from the contaminated water 620, thus allowing a relatively high degree of adsorption in relatively short contact times. In some embodiments, the treatment method includes contacting the contaminated water 620 with the modified wood pulp 200, 300 for at least 5, 10, 15, 30, 45, 60, 120, 240, or 600 sec. The upper bound for the contact time is not particularly limited, as net adsorption efficiency increases with time, albeit at a reducing rate as time progresses. In various embodiments, contact times can be up to 1, 2, 5, 10, 15, 30, 45, 60, 120, 250, 500, or 1000 minutes. The time sufficient for PFAS adsorption in the contacting step can represent the total contact time in a batch adsorption vessel or a residence time in a continuous-flow adsorption vessel (e.g., V/Q as a ratio of volume to volumetric flowrate through the vessel).

The modified wood pulp 200, 300 advantageously can provide a relatively high separation or adsorption capacity for capture and removal of PFAS contaminants 622 from the contaminated water 620, thus allowing a comparatively larger volume of contaminated water 620 to be treated before replacing spent wood pulp with fresh modified wood pulp 200, 300. In some embodiments, the modified wood pulp 200, 300 can have an adsorption capacity in a range of 500 to 1000 mg PFAS/g modified wood pulp (dry weight). For example, the adsorption capacity can be at least 500, 600, or 700 and/or up to 700, 800, 900, or 1000 mg PFAS/g modified wood pulp. Put another way, the loaded wood pulp 640 can include 500 to 1000 mg PFAS adsorbate 642 per gram of (previously) fresh modified wood pulp 200, 300 (dry weight).

The concentration of the PFAS contaminant 622 initially present in the contaminated water (e.g., as added to a batch vessel or continuously fed to a continuous vessel) is not particularly limited. In embodiments characteristic of typical wastewater to be treated, the PFAS can be present in the contaminated water 622 at a concentration in a range of 1 ng/L to 1 mg/L, although initial concentrations up to 10 mg/L, 100 mg/L, or higher are possible. For example, the initial PFAS concentration can be at least 1, 2, 5, 10, 20, 50, 100, or 200 and/or up to 5, 10, 20, 50, 100, 200, 500, or 1000 on a ppt (ng/L), ppb (μg/L), or ppm (mg/L) scale. The foregoing PFAS concentration ranges can apply collectively to all PFASs initially present (e.g., all anionic PFASs initially present and/or all cationic PFASs initially present), independently to individual PFASs initially present, etc.

The contaminated water 620 can have additional properties or components characteristic of typical wastewaters containing PFAS contaminants 622 for remediation. In an embodiment, the contaminated water can have a pH value in a range of 5 to 9, for example at least 5, 6, or 7 and/or up to 7, 8, or 9. In an embodiment, the contaminated water 620 can include sodium chloride at a concentration in a range of 0 to 100 mg/L, for example at least 0.1, 1, 2, 5, 10, or 20 mg/L and/or up to 10, 20, 30, 40, 50, 75, or 100 mg/L. The foregoing ranges can apply to sodium chloride collectively, sodium ions individually, and/or chloride ions individually. In an embodiment, the contaminated water 620 can include one or more ions characteristic of environmental waters, for example surface water or groundwater, such as calcium ions, sodium ions, magnesium ions, potassium ions, sulfate ions, chloride ions, fluoride ions, nitrate ions, etc. In an embodiment, the contaminated water 620 can include one or more natural organic matter (NOM) components such as one or more humic acids, one or more fulvic acids, one or more humins, etc.

An advantage of the disclosed modified wood pulp 200, 300 and treatment methods is that the modified wood pulp 200, 300 is relatively inexpensive to manufacture, so there is no need to recycle/recover the modified wood pulp 200, 300 from the loaded wood pulp 640 for re-use, for example by removing the adsorbed PFAS 642 thereon. Thus, the loaded wood pulp 640 can simply be discarded after being treated to degrade the adsorbed PFAS 642 thereon. Accordingly, in some embodiments, the loaded wood pulp 640 can be treated by any suitable destructive or degradation method to break down the adsorbed PFAS 642 into less toxic or non-toxic component relative to the original PFAS without regard to its effect on the underlying wood pulp. Suitable destructive or degradation techniques can include irradiation, microbial digestions, incineration, etc. In some cases, such techniques can also serve to break down the cellulosic portion of the modified wood pulp, or a second/subsequent degradation step (e.g., microbial) can be used to break down the wood pulp.

In the various embodiments described herein, the modified wood pulp 200, 300 is generally used in methods to treat/remediate contaminated water and remove PFAS therefrom. In other embodiments, the modified wood pulp 200, 300 can be used to treat a liquid medium contaminated with PFAS, for example a suitable liquid (organic) solvent capable of dissolving the PFAS contaminants. Such solvents can be used with or without added water. For example, a soil or other solid matrix/material containing PFAS contaminants can be first extracted with the liquid solvent to remove the PFAS therefrom and provide a contaminated solvent mixture containing the liquid solvent and the PFAS contaminants therein. The contaminated solvent mixture could then be treated with the modified wood pulp 200, 300 as described above to remove the PFAS contaminant from the solvent, for example to recycle/re-use the solvent for further extraction of additional soil or other solid materials.

### EXAMPLES

The following examples illustrate the disclosed compositions and methods, but are not intended to limit the scope of any claims thereto.

### Example 1—Quaternized Wood Pulp (QWP)

Cationic wood pulp, in particular quaternized wood pulp (QWP), was prepared and evaluated as an adsorbent for removing PFASs from water. As described in more detail below, QWPs could be generated in a one-step reaction with, and PFAS adsorption was particularly effective when using high charge density QWPs. At environmentally relevant concentrations (˜2.5 μg/L), PFOS and PFOA were rapidly adsorbed in under 30 s, making QWPs advantageous compared to other adsorbents which require long adsorption times (>15 min). The maximum adsorption capacity for PFOS and PFOA on sample QWP1.5 was determined to be 763 and 605 mg/g, respectively, which outperforms similar adsorbents and activated carbon (AC). WP is biodegradable and inexpensive, making it a practical platform for augmenting PFAS adsorption.

Materials: Bleached hardwood pulp, hydrochloric acid (ACS reagent, 37%), acetone, sodium hydroxide (NaOH), 2-propanol (IPA), glycidyl trimethyl ammonium chloride (GMAC), sodium nitrate, humic acid (HA), perfluorooctanoic acid (PFOA, CAS #335-67-1), heptadecafluorooctane sulfonic acid potassium salt (PFOS, CAS #2795-39-3), potassium nonafluoro-1-butanesulfonate (PFBS, CAS #29420-49-3), heptafluorobutyric acid (PFBA, CAS #375-22-4), undecafluoro-2-methyl-3-oxahexanoic acid (GenX, CAS #13252-12-6), sodium 1H,1H,2H,2H-perfluorooctane sulfonate (6:2 FTS, CAS #27619-94-9, 50 μg/mL in methanol), perfluorooctane sulfonamide (PFOSA, Acros, CAS #754-91-6), sodium chloride (NaCl), silver nitrate (NaNO₃), and methanol (certified ACS) were obtained from various commercial sources and used as received. Deionized (DI) water purified by a MILLIPORE SYNERGY water purification system was used as a water source.

Synthesis of Quaternized Wood Pulp (QWP): QWP samples were prepared having various charge densities, including QWP0.0, QWP0.65, QWP0.97, QWP0.99, and QWP1.5, where the number indicates the charge density in mmol —NR₃⁺/g (e.g., “QWP1.5” is a sample with a charge density of 1.5 mmol —NR₃⁺/g).

Wood pulp (WP) (1.0 g) was combined with DI water (50 mL) in a 100 mL round bottom flask. The mixture was left alone for 15 min to wet the fibers, and then, the mixture was homogenized at 18 k rpm for 2 min. The fibers were allowed to soak for 5 min, and the mixture was homogenized again at 18 k rpm for 2 min. The mixture was divided into two 50 mL polypropylene centrifuge tubes and water was added to fill the tubes (˜45 mL in each tube). The tubes were centrifuged at 2580×g for 4 min, the supernatant was discarded, and the solid from each tube was combined into a round bottom flask. 2-propanol (50.0 mL) was added to the flask along with NaOH (333.4 mg, 8.335 mmol) and a stir bar. The flask was then heated to 50° C. on a heating block and stirred for 45 min. After this activation time, a known volume of glycidyl trimethyl ammonium chloride (i.e., a selected amount corresponding to a final charge density as determined by conductimetric titration) was added with a micropipette over 0-4 min to the reaction, and the mixture was stirred for 2.25 h. The round bottom flask was then removed from the heating block and cooled in ice water for 5 min. The reaction was quenched with 5M HCl (˜3 mL) and stirred for 5 min. The mixture was vacuum filtered rinsed with DI water.

The fibers were then divided into two 50 mL polypropylene centrifuge tubes. Millipore water was added to fill the tubes (˜45 mL in each tube), the tubes were centrifuged at 3260×g for 7-10 min, and then the supernatant was discarded. This centrifuge cycling process was repeated to remove excess acid and ions from the fibers until the conductivity of the supernatant was less than or equal to 25 μS/cm. After this purification process, the fibers were removed from the centrifuge tubes, placed in 20 mL vials, frozen in liquid nitrogen, and dried under vacuum to remove excess water, thereby providing the QWP samples.

QWP Characterization: QWPs prepared as described above were analyzed using conductometric titrations to determine charge densities, and elemental analysis was used to verify the titration results. The quaternary amines can be functionalized at the C2 and/or C6 positions on the glucose repeat unit. Raman spectroscopy was performed on QWP fiber surfaces, depths, and cross-sections to demonstrate that uniform amination occurred throughout the fibers, which have interior amorphous regions (i.e., as opposed to only fiber surface modification which would be expected if there were no amorphous regions).

Test Mixtures: QWP mixtures with concentrations of 0.100 and 0.125 mg/mL were used for adsorption experiments. To make a 0.125 mg/mL mixture, QWPs (12.5 mg) were first soaked with water (10.0 mL) for 5 min in a 20 mL vial. The mixture was homogenized at 18 k rpm for 1 min to generate a 1.25 mg/mL QWP mixture. The 0.125 mg/mL mixture was then made by combining the 1.25 mg/mL QWP mixture (2.0 mL) and water (18.0 mL) in a new 20 mL vial. An analogous procedure was followed to make the 0.100 mg/mL QWP mixtures. PFOS and PFOA mixtures with concentrations of 20.0 mg/L were used for adsorption experiments. PFOS or PFOA (10.0 mg) was added to a 500 mL glass container with water (500.0 mL). The container was sonicated (˜2-3 min) to get all the PFOS or PFOA to dissolve.

Adsorption Experiment Methodology: A known volume of PFAS solution was placed in a 50 mL polypropylene centrifuge tube, and in some experiments, a known volume of solution with measured pH, humic acid, or NaCl was added as well. Next, a volume of QWP mixture with known concentration and water were syringed over 10 s into the bottom of the centrifuge tube while vortex mixing at a speed of 1.5. The tube was vortex mixed for an additional 10 s using the same speed. The centrifuge tube was removed from the vortex mixer, and an aliquot was taken with a 3 mL plastic syringe, filtered through a cellulose acetate syringe filter, and placed in either a 2 mL glass vial or a 15 mL centrifuge tube for subsequent analysis via LC/MS techniques to determine the degree of PFAS adsorption (e.g., expressed as a % adsorbed by the QWPs relative to the initial amount present in the PFAS solution). Aliquots were removed at selected contact times after mixing the QWPs with PFAS to evaluate the effect of contact time on adsorption. As reported in this example, PFAS adsorption (%) and adsorption capacity of the QWPs (q, mg/g) were determined using the following equations, where C₀ is the initial PFAS concentration, C is the residual PFAS concentration after adsorption, and C_{A} is the adsorbent (QWP) concentration):

PFAS adsorption (%)=(C₀−C)/C₀×100 (1)

Adsorption capacity (q)=(C₀−C)/C_{A} (2)

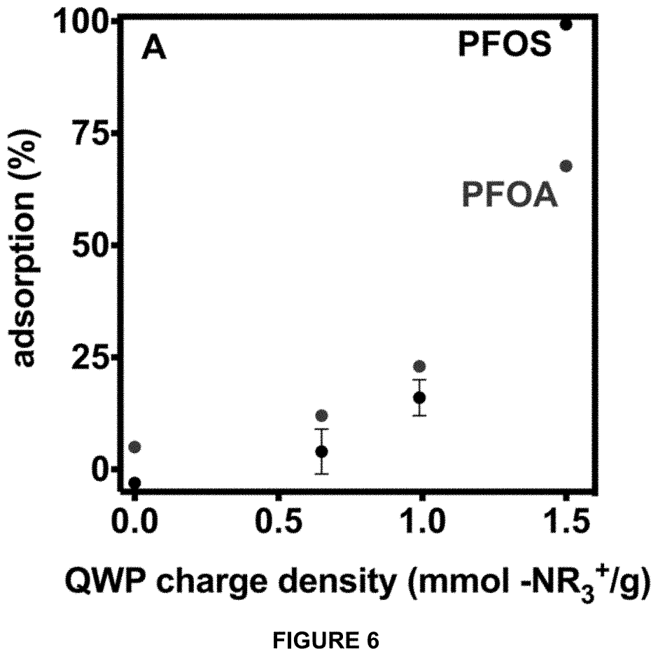

QWP Adsorption Results: As an initial test, QWPs with CDs from 0.0-1.5 mmol —NR₃⁺/g were mixed in PFOS or PFOA solutions, and adsorption was analyzed after 30 s of contact time (FIG. 6). As shown in FIG. 6, nearly 100% of PFOS and 70% of PFOA were removed from solution with the highest CD QWP (QWP1.5). QWPs with lower CDs (QWP0.99 and QWP0.65) adsorbed less than 16% of PFOS and 23% of PFOA. These results demonstrates that higher CDs on QWPs leads to more PFOS/PFOA adsorption. Moreover, PFAS adsorption on QWPs occurs primarily via electrostatic interactions because the QWP with no cationic charges removed a negligible amount of anionic PFAS. QWP1.5 was selected for many of the following experiments because it exhibited the highest adsorption percent compared to the other QWPs. Tables 1 and 2 below summarize adsorption and adsorption capacity for PFOS (Table 1) and PFOA (Table 2) over a range of different contact times for an adsorbent concentration (C_{A}) of 50 mg/L and initial PFAS concentrations (C₀) of 5 mg/L.

TABLE 1
PFOS adsorption (%) and capacity (mg/g) vs. QWP charge density (mmol NR₃⁺/g)

| | PFOS adsorption | | PFOS adsorption 60 | | PFOS adsorption | | PFOS adsorption | |
|---|---|---|---|---|---|---|---|---|
| | 0.167 min after mixing | | or 80 min after mixing | | 480 min after mixing | | 1440 min after mixing | |
| QWP | ads % | capacity | ads % | capacity | ads % | capacity | ads % | capacity |
| no QWP | 0 ± 3 | 0 ± 2 | | — | | — | 9 ± 2 | 7 ± 1 |
| QWP0.0 | −3 ± 1 | −2 ± 1 | 9 ± 7 | 8 ± 5 | 12 ± 3 | 10 ± 2 | 6 ± 1 | 5 ± 1 |
| QWP0.65 | 4 ± 5 | 3 ± 4 | 14 ± 8 | 12 ± 6 | 63 ± 7 | 52 ± 6 | 76 ± 10 | 63 ± 8 |
| QWP0.99 | 16 ± 4 | 13 ± 3 | 52 ± 4 | 43 ± 3 | 95 ± 1 | 79 ± 1 | 99.11 ± 0.05 | 82.26 ± 0.04 |
| QWP1.5 | 99.3 ± 0.1 | 82.42 ± 0.09 | 99.47 ± 0.03 | 82.57 ± 0.02 | 99.5 ± 0.1 | 82.56 ± 0.04 | 99.51 ± 0.01 | 82.60 ± 0.01 |

TABLE 2
PFOA adsorption (%) and capacity (mg/g) vs. QWP charge density (mmol NR₃⁺/g)

| | PFOA adsorption | | PFOA adsorption | | PFOA adsorption | | PFOA adsorption | |
|---|---|---|---|---|---|---|---|---|
| | 0.167 min after mixing | | 80 min after mixing | | 480 min after mixing | | 1440 min after mixing | |
| QWP | ads % | capacity | ads % | capacity | ads % | capacity | ads % | capacity |
| no QWP | 0 ± 2 | 0 ± 1 | 10 ± 1 | 8 ± 1 | 8 ± 2 | 6 ± 1 | 4 ± 2 | 3 ± 1 |
| QWP0.0 | 5 ± 1 | 4 ± 1 | 10 ± 1 | 8 ± 1 | 8 ± 2 | 7 ± 1 | 6.2 ± 0.3 | 4.9 ± 0.3 |
| QWP0.65 | 12 ± 1 | 9 ± 1 | 30 ± 2 | 23 ± 2 | 48 ± 10 | 37 ± 8 | 50 ± 10 | 39 ± 8 |
| QWP0.99 | 23 ± 1 | 18 ± 1 | 53 ± 2 | 42 ± 1 | 90 ± 1 | 70 ± 1 | 96.3 ± 0.4 | 75.3 ± 0.3 |
| QWP1.5 | 67.7 ± 0.4 | 52.9 ± 0.3 | 83 ± 2 | 65 ± 2 | 94 ± 1 | 73 ± 1 | 98 ± 1 | 77.1 ± 0.4 |

Various amounts of QWP1.5 were added to PFOS solutions, and PFOS adsorption was measured after 30 s of contact time to evaluate the effect of adsorbent concentration (C_{A}) on absorption capacity (q). The results are shown in Table 3. A small QWP1.5 dosage of 1.25 mg/L resulted in negligible PFOS adsorption but increasing the dosage to 12.5 mg/L resulted in a PFOS adsorption capacity of 263±3 mg/g. Further increasing the dosage to 50.0 mg/L resulted in a decreased adsorption capacity of approximately 80 mg/g. This trend suggests that employing too much QWP1.5 results in inefficient use of available cationic sites, and a smaller dosage maximizes PFAS adsorption. Thus, an adsorbent concentration (or dosage) of 10.0 mg/L was selected for many of the following experiments.

TABLE 3
PFOS adsorption (%) and capacity (mg/g)
vs. QWP1.5 concentration (mg/L).

| QWP1.5 | | PFOS |
|---|---|---|
| concentration | PFOS | adsorption |
| (mg/L) | adsorption % | capacity |
| 1.25 | −1.8 ± 0.3 | −71 ± 10 |
| 6.25 | 25 ± 2 | 190 ± 10 |
| 12.5 | 68 ± 1 | 263 ± 3 |
| 50.0 | 99.3 ± 0.1 | 82.42 ± 0.09 |

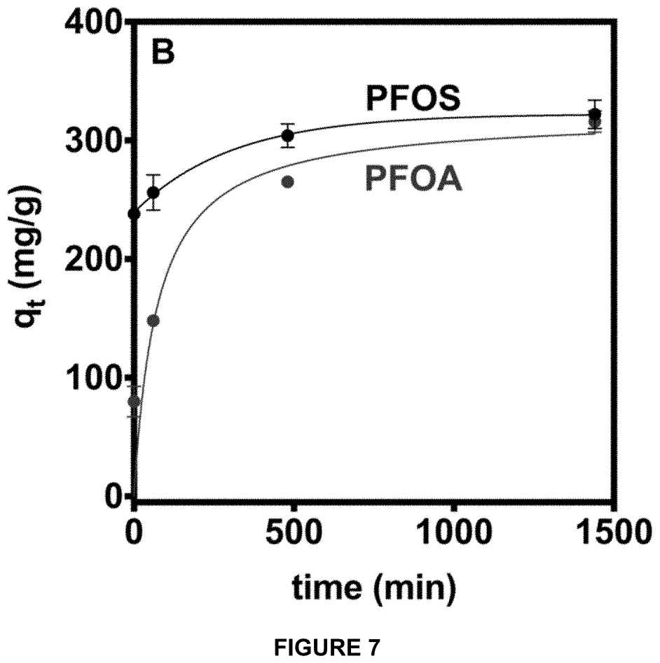

To determine if adsorption equilibrium is achieved within 30 s of contact time, PFOS and PFOA adsorption capacities (qₜ) on QWP1.5 were monitored over 24 h (FIG. 7). It was found that after 30 s of contact time, PFOS adsorption capacity was 238±5 mg/g, corresponding to 67±1% of PFOS adsorbed, and PFOA adsorption capacity was 80±10 mg/g, with 20±3% of PFOA adsorbed. It was also observed that adsorption equilibrium was not achieved in 30 s, but was achieved after longer contact times (e.g., about 8 and 24 h of contact time for PFOS and PFOA, respectively). Tables 4 and 5 summarize the full results, further including absorption (%) values and control values (i.e., control experiments performed as described above with PFAS but no QWPs to determine initial PFAS concentrations and to confirm minimal PFAS loss).

TABLE 4
Measured and adjusted PFOS adsorption over time using QWP1.5

| | measured | measured PFOS | | PFOS control | adjusted PFOS |
|---|---|---|---|---|---|
| time | PFOS | adsorption | PFOS control | adsorption | adsorption |
| (min) | adsorption (%) | capacity (mg/g) | adsorption (%) | capacity (mg/g) | capacity (mg/g) |
| 0.167 | 67 ± 1 | 238 ± 5 | 0 ± 2 | 0 ± 7 | 238 ± 5 |
| 60 | 76 ± 4 | 270 ± 20 | 4 ± 1 | 13 ± 4 | 260 ± 20 |
| 480 | 89 ± 3 | 320 ± 10 | 3.0 ± 0.2 | 12 ± 1 | 300 ± 10 |
| 1440 | 96 ± 3 | 340 ± 10 | 5.0 ± 0.6 | 19 ± 2 | 320 ± 10 |

TABLE 5
Measured and adjusted PFOA adsorption over time using QWP1.5

| | measured | measured PFOA | | PFOA control | adjusted PFOA |
|---|---|---|---|---|---|
| time | PFOA | adsorption | PFOA control | adsorption | adsorption |
| (min) | adsorption (%) | capacity (mg/g) | adsorption (%) | capacity (mg/g) | capacity (mg/g) |
| 0.167 | 20 ± 3 | 80 ± 10 | 0 ± 2 | 0 ± 7 | 80 ± 10 |
| 60 | 42 ± 1 | 164 ± 3 | 4 ± 1 | 16 ± 3 | 148 ± 3 |
| 480 | 70 ± 2 | 273 ± 3 | 2 ± 1 | 8 ± 4 | 265 ± 3 |
| 1440 | 83 ± 2 | 324 ± 9 | 2 ± 1 | 8 ± 2 | 316 ± 9 |

Adsorption isotherms were generated to determine QWP1.5's maximum adsorption capacity for PFOS and PFOA. Isotherm data was collected by soaking QWP1.5 in either PFOS or PFOA solutions for 24 h and measuring the equilibrium PFOS/PFOA concentrations (Cₑ) in solution. The resulting data were fit with Langmuir and Freundlich isotherm models (not shown). The Langmuir model was found to best fit the data, according to linear least squares regression, and thus adsorption likely occurs at specific sites on the cationic wood pulp with the PFASs adsorbing in one layer on the fiber surface. Using the Langmuir model, it was calculated that the maximum adsorption capacity (qₘₐₓ) for PFOS and PFOA was 763 and 605 mg/g, respectively. The difference in qₘₐₓ between PFOS and PFOA is attributed to a sulfate group's increased affinity for electrostatic interactions with charged amine groups relative to a carboxylate. Additionally, because PFASs are typically found at concentrations from low ng/L to hundreds of μg/L in the environment, distribution coefficients (K_{D}, L/g) were calculated to characterize the affinity of adsorbates for an adsorbent and estimate the magnitude of adsorption that would occur at low PFAS concentrations, using the isotherm data. K_{D} were determined using the linear portion of the adsorption isotherms (not shown), and log K_{D} values were calculated as 3.93 and 3.09 for PFOS and PFOA, respectively.

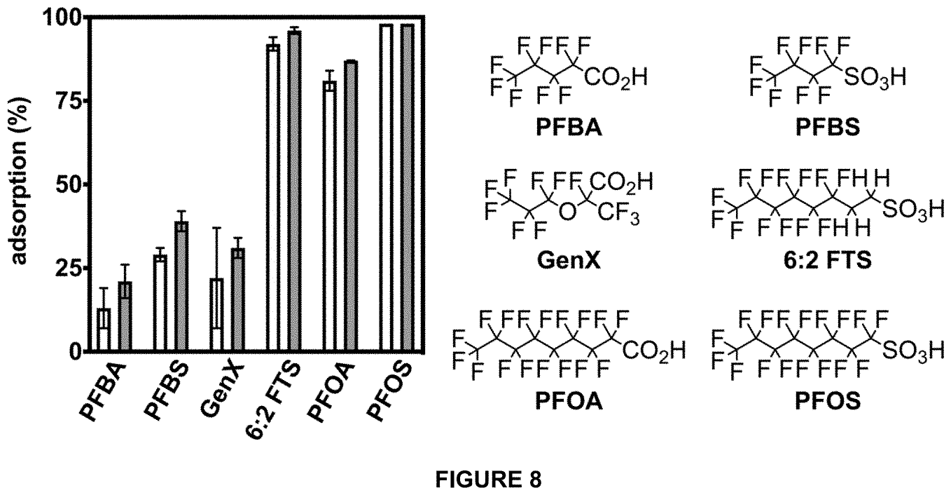

Effect of Multiple PFAS Species: In nature, water contains contaminants and a mixture of different PFASs at low concentrations (i.e., low ng/L to hundreds of μg/L). To determine whether QWP1.5 was effective for removing multiple types of PFASs, PFAS adsorption was evaluated after the cationic WP was mixed simultaneously with PFOS, PFOA, PFBS, PFBA, GenX, and 6:2 FTS as representative PFAS compounds (FIG. 8, right). After just 30 s of contact time, >80% adsorption of PFOS, PFOA, and 6:2 FTS were observed (FIG. 8, left). PFBS, PFBA, and GenX exhibited less effective adsorption, with adsorption between 13-29%. After 60 min of contact time, only small increases in PFAS adsorption were observed, with PFBS having the largest adsorption increase from 29 to 39% (FIG. 8, left). These results indicate that PFAS chain length plays a role in adsorption. More specifically, PFOS, PFOA, and 6:2 FTS with longer chain lengths are adsorbed more efficiently than PFBS and PFBA which have shorter chain lengths. Hydrophobic interactions are likely complementing electrostatic interactions in adsorbing PFASs. Furthermore, it was also observed that the PFAS functional group plays a role in adsorption. The PFASs with sulfate groups were more effectively adsorbed than the PFASs with carboxyl groups. Similar to the adsorption isotherm data, the increased adsorption percents were attributed to to the sulfate group's increased affinity for electrostatic interactions with charged amine groups.

Effect of Organic Matter: Natural organic matter (NOM) is a mixture of organic compounds in water that inhibits PFAS adsorption on conventional adsorbents. Therefore, various PFASs we adsorbed with humic acid (HA), a common type of NOM, present to simulate realistic water conditions. After 30 s of contact time, HA significantly reduced PFAS adsorption, with <20% of each PFAS being removed. Because HA is a complex mixture of charged and uncharged species, the decrease in PFAS removal is attributed to HA competing with PFASs for cationic and hydrophobic sites on QWP1.5.

Effect of pH: Water pH often adversely impacts PFAS adsorption because some adsorbents lose their cationic charge at environmentally relevant pHs of 5-9. QWPs, on the other hand, should not be impacted by pH because the cationic WP's quaternary amine has a pH-insensitive permanent charge, and PFOS/PFOA have pKa values below 3, meaning that the sulfonyl and carboxyl groups will be charged at pHs 5-9. Thus, PFOS and PFOA in solution were adsorbed at various pHs to imitate water from natural sources. After 30 s of contact time, it was observed that pH had no effect on the ability of QWP to adsorb PFOS or PFOA. The targeted initial PFAS concentrations in the adsorption and control trials were 2.50 μg/L, and the adsorbent dosage was 10.0 mg/L. Samples 1-3 were performed with final solution pHs of 5.06, samples 4-6 were performed with final solution pHs of 7.00, and samples 7-9 were performed with final solution pHs of 9.00. Table 6 summarizes the full results.

TABLE 6
PFOS and PFOA adsorption in solutions with various pHs.

| | | | | PFOS | | | PFOA |
|---|---|---|---|---|---|---|---|
| | | | PFOS | adsorption | | PFOA | adsorption |
| final | Solution | [PFOS] | adsorption | capacity | [PFOA] | adsorption | capacity |
| sample | pH | (μg/L) | (%) | (mg/g) | (μg/L) | (%) | (mg/g) |
| 1 | | 0.08* | | | 0.699 | | |
| 2 | 5.06 | 0.08* | 96 ± 0* | 0.19 | 0.831 | 73 ± 6 | 0.19 ± 0.02 |
| 3 | | 0.08* | | | 0.526 | | |
| 4 | | 0.08* | | | 0.947 | | |
| 5 | 7.00 | 0.08* | 97 ± 0* | 0.22 | 0.818 | 60 ± 10 | 0.15 ± 0.03 |
| 6 | | 0.08* | | | 1.40 | | |
| 7 | | 0.08* | | | 1.71 | | |
| 8 | 9.00 | 0.08* | 97 ± 0* | 0.23 | 0.930 | 60 ± 20 | 0.16 ± 0.05 |
| 9 | | 0.08* | | | 0.812 | | |

*Indicates that the measured PFAS concentration was below the limit of quantification (0.02 μg/L). Therefore, the limit of quantification was assumed to be the PFAS concentration and multiplied by the dilution factor (4). Standard deviations were calculated for these entries because of this estimation.

Effect of Salt: The influence of salt concentration on PFAS adsorption was also studied because water tends to have low concentrations of inorganic ions. After mixing QWP1.5 with PFOS or PFOA for 30 s in solutions containing NaCl (0-100 mg/L), it was observed that salt concentration had no impact on PFOS adsorption, similar to the pH experiment. PFOA adsorption, however, was found to decrease from >75% to nearly 30% as the NaCl concentration increased from 0 to 100 mg/L, likely due to electrostatic shielding between PFOA and QWP1.5's cationic sites. The difference in PFOS and PFOA adsorption is attributed to the increased sulfate affinity for cationic amines. Despite the reduction in PFOA adsorption at higher NaCl concentrations, adsorption is greater than 50% below PFOA concentrations of 25 mg/L, which is the range usually observed in freshwater samples. The targeted initial PFAS concentrations in the adsorption and control trials were 2.50 μg/L, and the adsorbent dosage was 10.0 mg/L. Samples 1-3 were performed with an NaCl concentration of 0 mg/L, samples 4-6 were performed with an NaCl concentration of 50 mg/L, samples 7-9 were performed with an NaCl concentration of 100 mg/L, and samples 10-12 were performed with an NaCl concentration of 9.3 mg/L. Table 7 summarizes the full results.

TABLE 7
PFOS and PFOA adsorption in solutions with various salt concentrations

| | | | | PFOS | | | PFOA |
|---|---|---|---|---|---|---|---|
| | | | PFOS | adsorption | | PFOA | adsorption |
| final | [NaCl] | [PFOS] | adsorption | capacity | [PFOA] | adsorption | capacity |
| sample | (mg/L) | (μg/L) | (%) | (mg/g) | (μg/L) | (%) | (mg/g) |
| 1 | | 0.08* | | | 1.21 | | |
| 2 | 0.0 | 0.08* | 97 ± 0* | 0.23 | 0.342 | 80 ± 20 | 0.2 ± 0.1 |
| 3 | | 0.08* | | | 0.304 | | |
| 4 | | 0.08* | | | 1.53 | | |
| 5 | 50.0 | 0.08* | 95 ± 0* | 0.17 | 1.97 | 40 ± 10 | 0.09 ± 0.03 |
| 6 | | 0.08* | | | 1.36 | | |
| 7 | | 0.1 | | | 1.93 | | |
| 8 | 100.0 | 0.08* | 95 ± 1 | 0.171 ± 0.001 | 1.80 | 31 ± 5 | 0.08 ± 0.01 |
| 9 | | 0.08* | | | 1.66 | | |
| 10 | | 0.08* | | | 0.947 | | |
| 11 | 9.3 | 0.08* | 97 ± 0* | 0.22 | 0.818 | 60 ± 10 | 0.15 ± 0.03 |
| 12 | | 0.08* | | | 1.40 | | |

*Indicates that the measured PFAS concentration was below the limit of quantification (0.02 μg/L). Therefore, the limit of quantification was assumed to be the PFAS concentration and multiplied by the dilution factor (4). Standard deviations were calculated for these entries because of this estimation.

Comparative Adsorbents: To demonstrate QWP1.5's effectiveness for adsorbing PFASs, PFAS adsorption capacities from QWPs were compared with other adsorbents. After 30 s of contact time in deionized water, PFOS and PFOA adsorption capacities were 238±5 and 80±10 mg/g on QWP1.5, which is better than the adsorption capacities for some activated carbons (ACs) and ion-exchange (IX) resins that utilized similar adsorption conditions and longer contact times. Furthermore, the maximum adsorption capacities (qₘₐₓ) for PFOS and PFOA using QWPs were calculated to be 763 and 605 mg/g, respectively, making QWP1.5 competitive with or better than the capacities of comparable adsorbents. For instance, ACs typically have qₘₐₓ below 600 mg/g and IX resins have qₘₐₓ ranging from −200-2600 mg/g. As described above, log K_{D}, which characterizes the affinity of adsorbates for an adsorbent, were calculated as 3.93 for PFOS and 3.09 for PFOA adsorption on QWP1.5. By comparison, AC and IX resins have log K_{D} less than 2.31, demonstrating that QWP1.5 has a better affinity for adsorbing PFOS and PFOA than conventional adsorbents.

### Example 2—Sulfated Wood Pulp (SWP)

Anionic-modified, sulfated WPs (SWPs) were formed by the following method. SWP samples were prepared having various charge densities, including SWP0.53, SWP1.0, SWP1.3, and SWP1.8, where the number indicates the charge density in mmol —SO₃⁻/g (e.g., “SWP1.8” is a sample with a charge density of 1.5 mmol —SO₃⁻/g).

Unsulfated WPs (400 mg) were placed in an oven-dried 100 mL flask with anhydrous DMF (50 mL), and the flask was capped with a septum. The mixture was soaked for 40 min without stirring under nitrogen. The mixture was then homogenized. The flask was re-capped and soaked for 10 min under nitrogen. The mixture was homogenized a second time. Then a stir bar was added, the flask was sealed, and the mixture was stirred for 40 min under nitrogen. A Schlenk flask with stir bar and addition funnel were removed from the oven and assembled. The addition funnel was capped with a septum, and the system was cooled to room temperature under nitrogen. Anhydrous DMF (26 mL) was added to the Schlenk flask, and the solvent was cooled in an ice water bath for 10 min. Then, chlorosulfonic acid (CSA; 4 mL) was loaded into the addition funnel and added slowly over 5 min to the stirring DMF, with some HCl evolving. Once all the CSA was added, the addition funnel was removed and the Schlenk flask was capped, removed from the ice-water bath, and warmed to room temperature to provide a 2.0 M solution of CSA in DMF. A specified amount of the 2.0 M CSA in DMF was added to the WP mixture dropwise over 0-2 min. The mixture was stirred for 20 min once all the CSA was added. Then, the reaction was quenched with methanol (˜5 mL), and the mixture was stirred for 5 min.

The mixture was poured into a 250 mL centrifuge bottle, and the bottle was filled to ˜90% capacity with DI water. The mixture was centrifuged at ˜34,000×g for ˜25 min. The supernatant was discarded, and fresh DI water was added. Then a ˜0.1 M NaOH solution was used to increase the pH to 7, as measured with pH paper. The mixture was centrifuged again at ˜34,000×g for ˜25 min. The supernatant was discarded, and fresh DI water was added. The mixture was shaken by hand and then centrifuged a third time at ˜34,000×g for 25 min. The fibers were then isolated using one of the two procedures described below. (i) If a white, gel-like mass remained in the centrifuge bottle, the supernatant was discarded, and the material was placed in smaller glass vials, frozen in liquid nitrogen, and dried under vacuum on a Schlenk line to remove excess water. (This procedure was used to prepare SWP1.8.) (ii) If the fibers did not form a gel-like mass in the centrifuge bottle, ˜90% of supernatant was discarded, and the remaining mixture was vacuum filtered using a Whatman polyamide membrane filter (0.2 μm, 47 mm). The fibers on the filter were then rinsed once with DI water (5 mL), and placed in smaller glass vials, frozen in liquid N2, and dried under vacuum on a Schlenk line to remove excess water. (This procedure was used to prepare SWP0.53, SWP1.0, and SWP1.3.)

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compounds, compositions, methods, and processes are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A cationic-modified wood pulp comprising:
a cellulosic backbone; and
a plurality of cationic groups each of which is attached to the cellulosic backbone via a corresponding linking group containing 1 to 6 carbon atoms.

2. The cationic-modified wood pulp of claim 1, wherein the cationic group comprises an ammonium group.

3. The cationic-modified wood pulp of claim 1, wherein the linking group comprises an ether reaction product between an epoxide-functional cationic group and an original hydroxyl group of the cellulosic backbone.

4. The cationic-modified wood pulp of claim 1, wherein the cationic-modified wood pulp is free from functionalizing groups other than the cationic groups.

5. The cationic-modified wood pulp of claim 1, wherein the cationic groups are present in an amount in a range of 0.1 mmol to 8 mmol cationic group per gram of cationic-modified wood pulp.

6. The cationic-modified wood pulp of claim 1, wherein the cationic groups are present in an amount in a range of 0.01 to 1 cationic groups per cellulosic backbone repeat unit.

7. The cationic-modified wood pulp of claim 1, wherein the cationic groups are present in an amount in a range of 0.02 g to 0.5 g cationic group per gram of cellulosic backbone.

8. An anionic-modified wood pulp comprising:
a cellulosic backbone; and
a plurality of anionic groups each of which is attached to the cellulosic backbone either (i) directly or (ii) via a corresponding linking group containing 1 to 6 carbon atoms.

9. The anionic-modified wood pulp of claim 8, wherein the anionic group comprises a sulfonate group.

10. The anionic-modified wood pulp of claim 8, wherein the linking group is present and comprises an ether reaction product between a epoxide-functional anionic group and a hydroxyl group of the cellulosic backbone.

11. The anionic-modified wood pulp of claim 8, wherein the anionic-modified wood pulp is free from functionalizing groups other than the anionic groups.

12. The anionic-modified wood pulp of claim 8, wherein the anionic groups are present in an amount in a range of 0.1 mmol to 8 mmol anionic group per gram of anionic-modified wood pulp.

13. The anionic-modified wood pulp of claim 8, wherein the anionic groups are present in an amount in a range of 0.01 to 1 anionic groups per cellulosic backbone repeat unit.

14. The anionic-modified wood pulp of claim 8, wherein the anionic groups are present in an amount in a range of 0.02 g to 0.5 g anionic group per gram of cellulosic backbone.

15. The cationic-modified wood pulp of claim 1, wherein:
the cellulosic backbone is derived from a wood pulp selected from the group consisting of softwood wood pulp, bamboo wood pulp, hardwood wood pulp, and combinations thereof; and
the cellulosic backbone has an amorphous content in a range of 30% to 70%.

16. The cationic-modified wood pulp of claim 1, wherein the cationic-modified wood pulp is in the form of fibers.

17. The cationic-modified wood pulp of claim 1, wherein the cationic-modified wood pulp is in the form of granules.

18. A method for treating water contaminated with a perfluoroalkyl substance, the method comprising:
providing a contaminated water comprising (i) water and (ii) a perfluoroalkyl substance (PFAS) in the water; and
contacting the contaminated water with the cationic-modified wood pulp of claim 1 for a time sufficient to adsorb at least a portion of the PFAS from the contaminated water, thereby forming (i) a treated water having a reduced PFAS content and (ii) a loaded wood pulp comprising the cationic-modified wood pulp and adsorbed PFAS thereon.

19. The method of claim 18, wherein:
the PFAS has 4 to 20 perfluorinated carbon atoms; and
the PFAS has at least one of an anionic group and a cationic group.

20. The method of claim 18, wherein:
the PFAS comprises an anionic PFAS; and
the loaded wood pulp comprises the cationic-modified wood pulp and adsorbed anionic PFAS thereon.

21. The method of claim 18, wherein the treated water has a PFAS concentration that is 20% or less than that of the contaminated water.

22. The method of claim 18, comprising contacting the contaminated water with the cationic-modified wood pulp for at least 5 sec.

23. The method of claim 18, wherein the cationic-modified wood pulp has an adsorption capacity in a range of 500 to 1000 mg PFAS/g modified wood pulp.

24. The method of claim 18, comprising contacting the contaminated water with the cationic-modified wood pulp as a batch process or a continuous process.

25. The method of claim 18, wherein the PFAS is present in the contaminated water at a concentration in a range of 1 ng/L to 1 mg/L.

26. The method of claim 18, wherein the contaminated water has a pH value in a range of 5 to 9.

27. The method of claim 18, wherein the contaminated water further comprises sodium chloride at a concentration in a range of 0 to 100 mg/L.

28. The method of claim 18, wherein the contaminated water further comprises a natural organic matter (NOM) component selected from the group consisting of humic acids, fulvic acids, humins, and combinations thereof.

29. The method of claim 18, further comprising:
treating the loaded wood pulp to degrade the adsorbed PFAS thereon.

30. A method for treating water contaminated with a perfluoroalkyl substance, the method comprising:
providing a contaminated water comprising (i) water and (ii) a perfluoroalkyl substance (PFAS) in the water; and
contacting the contaminated water with the anionic-modified wood pulp of claim 8 for a time sufficient to adsorb at least a portion of the PFAS from the contaminated water, thereby forming (i) a treated water having a reduced PFAS content and (ii) a loaded wood pulp comprising the anionic-modified wood pulp and adsorbed PFAS thereon.
